(19) United States
(12) Patent Application Publication
(10) Pub. No.: US 2016/0253690 A1
(43) Pub. Date: Sep. 1, 2016

(54) SYSTEM AND METHOD FOR PRICE ANALYSIS AND OPTIMIZATION

(71) Applicant: Thomas E. Richardson, Naperville, IL (US)

(72) Inventor: Thomas E. Richardson, Naperville, IL (US)

(21) Appl. No.: 15/055,056

(22) Filed: Feb. 26, 2016

Related U.S. Application Data
(60) Provisional application No. 62/120,963, filed on Feb. 26, 2015.

(51) Int. Cl. G06Q 30/02; G06Q 40/00; G06Q 20/20

(52) U.S. Cl. CPC G06Q 30/0206; G06Q 20/202; G06Q 40/12

(57) ABSTRACT

A system and method for providing insights into pricing strategy for a retail store, particularly for optimizing prices of fast moving, long life cycle items in the consumer package goods industries is disclosed. The system includes a computer having a display, a processor, and memory, an input device for allowing a user to interact with the computer processor and display to change one or more parameters of sales and gross margin percent (GM %) so as to determine a price for at least one item for sale and an output device for outputting new pricing information for the at least one item. The method includes steps of receiving sales and cost data for items, displaying one or more graphs of sales and GM % for a plurality of items, iteratively updating the graphs based on user selected optimization parameters and outputting new prices for the one or more items based on the optimization.

### PRIORITY

This application claims priority to provisional application U.S. Ser. No. 62/120,963 filed Feb. 26, 2015 titled Price Optimization System and Method.

### FIELD OF THE INVENTION

The invention relates generally to a computer-implemented system and method for analyzing and optimizing prices of fast moving, long life cycle items in the consumer package goods industries.

### BACKGROUND OF THE INVENTION

There are several stakeholders who impact the ultimate price of an item for sale. Manufacturers create brands and develop products to satisfy or create customer demand. They create the value of products and establish the cost at which they are sold to retailers.

Retailers represent the stores where consumer package goods (CPG) are sold to customers. Retailers determine the assortment of manufacturers' products to be sold. While there are many components of the Value Proposition an individual retailer offers to customers, price is a major factor. While price times movement determines sales or revenue, it is important to note that cost can represent 75% of revenue.

Competitors also impact pricing decisions, since customers can choose to shop at a variety of retailers. It is a crucial imperative for each retailer to establish their strategic differentiation.

Finally, customers ultimately determine the success of products. Through their purchases, they will determine the value of the products. These purchases are represented by the scanning data retailers capture from the point-of-sale equipment and store in their data warehouses. Typically, forecasted movement from historical sales data is the most important decision variable for developing a regular pricing strategy.

Therefore, precise pricing decisions that maximize profit while retaining customers are crucial to the success of a retailer. Furthermore, in the industry sectors of Grocery, Drug or Hardware, for example, a retailer must determine prices for possibly tens of thousands of items within hundreds of categories and across hundreds of stores. At a basic level, prices must be high enough for the retailer to make a profit yet low enough to encourage shoppers to both enter the store and make purchases once they are there.

In reality, many variables add complexity to pricing decisions beyond just the sheer quantity of items in a typical package goods store, such as a grocery store. For example, retailers must consider everything from the mix of items within categories and gross margin percent to key value items and shopping basket size. Retailers must also consider competitors, from traditional supermarkets to dollar stores, to on-line outlets.

Computerization has taken pricing information that was initially tracked on hand written pricing tray cards through stages of key punch data processing, then electronic data entry and report generation. Continued desire for improvement in productivity, automation and control has led to the development of computer and even cloud-based price management systems, which include many if not most of the variables pertinent to pricing in one place. Rules based systems were developed to cope with the complexity but they were often developed by programmers who didn't understand pricing, then turned over to pricing professionals who didn't understand programming and thus required a steep learning curve to work with the software. Even after learning a system, the results it generated were often incomprehensible to the pricing professionals, or so dumbed down as to be worthless.

There are several mathematical concepts used in price optimization. Elasticity, represented by E, is the responsiveness of a quantity of goods demanded to changes in its price. It is generally represented by the formula

ε=((Qₙ−Q₀)/Q₀)/((Pₐ−P₀)/P₀) (1)

where Q₀ is the original quantity sold at price P₀ and Qₙ is the new quantity sold at price Pₙ. The calculation of elasticity is dependent on the demand model used. Three main demand models are referred to as Ratio, exp % and Exp. The Ratio method is the simplest and uses equation (1) for elasticity. The exp % model uses equation (2) while the Exp model uses equation (3).

β=((ln(Qₙ/Q₀))/((Pₙ−P₀)/P₀) (2)

α=((ln(Qₙ/Q₀)/(ln(Pₙ/P₀)) (3)

Elasticity values are less than zero. The different models of demand also have different equations for Qₙ:

Qₙ=Q₀·(1+ε·(Pₙ−P₀)/P₀), Ratio method (4)

Qₙ=Q₀·exp((β·(Pₙ−P₀)/P₀), exp % method (5)

Qₙ=Q₀·(Pₙ/P₀)^{α}, Exp method (6)

This results in formulas for the Optimum Profit Price of:

PRₒₚₜ=(C+P₀·(ε−1)ε)/2, Ratio method (7)

PRₒₚₜ=C−(P₀/β), exp % method (8)

PRₒₚₜ=C·(α/(α−1)) for α<−1, Exp method (9)

where C=cost. Note that equations (7) and (8) depend on P₀. Equation (9) is independent of price. Also, the Exp method of equation (9) does not have an optimum profit price for −1≦α<0. In other words, there is no optimum price for insensitive items.

The Ratio (Straight Line) method of calculating Elasticity is most conservative. For a price increase, demand will reduce the most with the Straight Line model. This will be the worst case. It is conservative in predicting the worst case knowing that might not occur. For a price decrease, the demand will increase the least and if more, than things will be better.

The Exp method (Exponent Curve) is the most extreme compared to Straight Line. The demand decreases the slowest and never gets to zero. For price decreases the demand increases very aggressively in an exponential manner. It is the fastest increase. Note this is more appropriate for promotions with 25% to 50% price decreases.

The exp % method is in between the other two. Since this method has finite demand as price approaches zero, it does have an unconstrained optimum revenue price. The profit and demand curves for optimum profit for the Ratio Method are shown in FIG. 1. Profit on the left and Quantity on the right are plotted vs. Price along the bottom of the graph. The Profit curve is displayed as line 10. Although specific values are shown, these are representative. Movement, or demand, is shown at line 12. With a cost, for example, of $0.8 and an elasticity of −2.0, the optimum price is $1.15, as shown by line 14.

It is generally accepted that within a 5% price change consumers may not change their shopping behavior. At elasticity value of −3, for the Ratio method, the optimum profit price increase is 6.7% and that is close to the range of not having consumer behavior change. But for elasticity value of −3 there is significant sensitivity and that conclusion may not hold true. Also at that sensitivity value a 20% margin may not be a competitive price to start with. Other optimum profit prices for lower Elasticity values and/or Demand Models are generally too high for the competitive Grocery Industry.

Another concept useful for determining pricing strategies is the quantity sold when P=0, and the price when Q=0 for an elasticity of −2 is shown in Table 1:

| | | Value | | Value |
|---|---|---|---|---|
| Method | Quantity @ P = 0 | Qₒ = 100 | Price @ Q = 0 | Po = $10.00 |
| Ratio | Qₒ · (1 − ε) (10) | 300.0 | Pₒ · [(ε − 1)/ε] | $15.00 |
| | | | (11) | |
| exp % | Qₒ · exp (−β) (12) | 738.8 | unbounded | ∞ |
| Exp | unbounded | ∞ | unbounded | ∞ |

For the Ratio and exp % methods with bounded quantity at P=0, there is an unconstrained optimum revenue price. For the Exp method there is an unbounded demand as price approaches zero (0) and this method has no unconstrained optimum revenue for P>0.

For the Optimum Revenue Formula, the following relationships are true, as in Table 2:

| | Optimum | Value at P = $10.00 and |
|---|---|---|
| Method | Revenue Price | Elasticity = −2.0 |
| Ratio | (½) · Pₒ · [(ε − 1)/ε] | $7.50 |
| exp % | −Pₒ/β | $5.00 |

| | |
|---|---|
| Exp | Unbounded without constraints |

For the above example, C=$8.00, P=10.00 and elasticity=−2.0. The optimum revenue prices are at a loss. The optimum revenue GM % in this example is −6.67% GM % for the Ratio method and −40.00% GM % for the exp % method. The optimum revenue price is always less than the optimum profit price.

Another important relationship is the variable elasticity values for different prices on the demand/profit curves as shown in Table 3:

| Method | Formula | |
|---|---|---|
| Ratio | εₙ = Pₙ/(Pₙ − Pₒ · ((εₒ − 1)/εₒ)) | (13) |
| | As Pₙ → 0, εₙ → −0 | |
| | As Pₙ → Pₒ · ((εₒ − 1)/εₒ)), εₙ → −∞ | |
| exp % | βₙ = βₒ · (Pₙ/Pₒ) (17) | |
| | As Pₙ → 0, βₙ → −0 | |
| | As Pₙ → ∞, βₙ → −∞ | |
| Exp | α is constant | |

For the Ratio and exp % methods, it makes sense that as prices are lower, customers would become less sensitive to price. And as prices are increased, customer would become more sensitive. Additionally, it does not make common sense to price higher than the optimum profit price, since the same profit can be achieved with a much lower price. As a result there is no practical or rational reason to be looking at prices where movement goes to zero. However, it is a very important mathematical price since the price where movement equal zero is a critical price point in the formula for optimum profit and revenue for the Ratio method.

To summarize, there are negligible differences in demand models for rational price changes. It can also be demonstrated that elasticity is not a very significant factor in profitability, either, especially for highly competitive items with a low GM %.

Each of a retailer's stores can be different, serving a large demographic and life stage variety of consumers, each of which have various motives and influences in their purchasing decisions which may also change day-to-day and even between hours in a single day. In addition, departments within a store, for example, meat, produce, grocery, frozen food, dairy, health and beauty care and general merchandise have different pricing requirements and strategies. Further, within a department there may be categories, sub-categories and even individual items with different roles, goals, and objectives as targeted to specific consumers.

To make sense of the vast number of decisions to be made, many pricing professionals turn to the field of Category Management. This discipline uses the Category Management Role Matrix developed by Professor Robert Blattberg for the Food Marketing Institute (FMI) as shown in FIG. 2. The quantitative measures of this chart provide unbiased, common language and universal standard roles for making pricing decisions. The key dimensions are GM % and Sales volume in dollars. The parameters for these dimensions are decision variables, but experience has shown 50/50 is good for Gross Margin and 50%, 30%, and 20% are good for Sales Dollars.

A 50/50 split for GM % means items that are below the category GM % and items that are above the category GM %. The 50/30/20 split for Sales Volume represents the items that account for the highest 50% of the total category sales, the next 30%, and the lowest 20% of sales. Note the number of items in the top 50% of sales is generally (always) the fewest number of items. Items with a low GM % may have a high volume, representing a retailer's core traffic 20. Items with a medium sales volume and lower than average GM % are in the role “Under Fire” at 22 while lower sales volume items and lower GM % are candidates for pricing rehabilitation at 24.

Items with a high GM % are divided into flagship items 26 with a high sales volume, cash machine items 28 with a medium sales volume and maintenance items 30 with a low sales volume. What do the 50%, 30% and 20% mean? Within this chart there are many scenarios to consider. For example, a Key Value Item (KVI) 32 is highly competitive and usually has a high sales volume and low GM %. A traditional item 34 is more stable and has a mid to high GM % and medium sales volume. Finally, an upscale item 36, for example, a unique or gourmet item, has a high GM % but also a low sales volume. In general, the fastest moving items will be in the Core Traffic 20 section, while the slower moving items will be in the Maintenance 30 section.

Simplified profit and demand curves are shown in FIG. 3. Profit is shown as line 40 while demand is shown as line 42. The horizontal axis represents price, showing that demand decreases as price increases and profit increases to a point, then starts to decline. Items 32, 34 and 36 generally fall at different prices as shown.

Thus, a need exists for a comprehensive price analysis and optimization system that provides a more understandable, actionable and improved decision making process to achieve the long term objectives of a profitable and sustainable business.

### SUMMARY OF THE INVENTION

The invention encompasses a system and method for providing insights into pricing strategy for a retail store, particularly for optimizing prices of fast moving, long life cycle items in the consumer package goods industries.

The invention in one implementation encompasses a system for analyzing and determining prices of fast moving, long life cycle items in consumer package goods industries, said system comprising a plurality of point-of-sale terminals for generating unit sales data and storing it in a memory; a computer processor operatively coupled to the memory for processing the unit sales data and associated unit cost data to generate graphs based on parameters of at least price, sales and gross margin percent (GM %); a display for displaying the graphs to a user; an input device for allowing a user to interact with the computer processor and display to change one or more parameters so as to determine a price for at least one unit; and an output device for outputting new pricing information for the at least one unit.

Another implementation of the invention encompasses a computer-implemented method for analyzing and determining prices of fast moving, long life cycle items in consumer package goods industries, said method comprising the steps of receiving sales data for one or more items from a plurality of point-of-sale terminals; receiving cost data for the one or more items; analyzing, by a processor, the sales data and cost data to generate one or more graphs of sales and gross margin percent for a plurality of items or groups of items; adjusting parameters in the one or more graphs to analyze prices of the one or more individual items or groups of items; outputting, by the processor, adjusted prices for the items.

Another implementation of the invention encompasses a method for optimizing prices of fast moving, long life cycle items in consumer package goods retail outlets, using a computer having a display, one or more processors, and one or more memories storing data and one or more programs for execution by the one or more processors, said method comprising the steps of receiving sales and cost data for one or more items; displaying a graphical user interface on the display, wherein the graphical user interface comprises one or more graphs of sales and gross margin percent (GM %) for a plurality of items and iteratively updating the graphs based on user selected optimization parameters; and outputting new prices for the one or more items based on the optimization.

In a further embodiment, the displaying step further comprises the steps of calculating a first total sales figure for all items in a set of items; generating a graph of the set of items in order of descending sales indexed to a range between a maximum and minimum item sales; calculating a GM % for each item in the set of items between user-selected minimum and maximum values of GM %, based on an inverse of its sales index, and generating a graph of the GM % for each item, in the same order; calculating a new price for each item in the set of items based on the calculated GM % for each item; calculating a second total sales figure for all of the items in the set of items based on the new prices; calculating a difference between the first and second total sales figures; if the difference is larger than a threshold, returning to the step of generating a graph of the set of items in order of descending sales, otherwise stopping the iteration.

### BRIEF DESCRIPTION OF THE DRAWINGS

Features of example implementations of the invention will become apparent from the description, the claims, and the accompanying drawings in which:

FIG. 1 illustrates prior art profit curve for relating price, cost and demand for an item for sale.

FIG. 2 illustrates a prior art Category Matrix for making pricing decisions.

FIG. 3 illustrates a simplified profit and demand curve

FIG. 4 illustrates a computer system that facilitates price analysis and optimization in accordance with one embodiment of the present invention.

FIG. 5 illustrates a more detailed view of a memory of the computer system of FIG. 4.

FIG. 6 illustrates a display of the computer system of FIG. 4 showing sales, GM % and profit graphs.

FIG. 7-9 illustrate the display of FIG. 6 for a specific example.

FIG. 10 illustrates a display according to a further embodiment of the invention.

FIG. 11 illustrates a Universal Optimization Chart (UOC) according to an embodiment of the invention.

FIG. 12 illustrates an alternative display of the UOC of FIG. 11.

FIG. 13 illustrates a further alternative to the display of the UOC of FIG. 11.

FIG. 14 illustrates a combined display of the embodiments of FIGS. 10 and 13.

FIG. 15 illustrates a further embodiment of the display of FIG. 14.

FIGS. 16-18 illustrate graphs for analyzing Optimum Revenue in accordance with the invention.

### DETAILED DESCRIPTION OF THE INVENTION

Price Management Systems along with Price Simulation and Optimization is a major component of a retailer's enterprise systems, or stores. These are key application systems for the Headquarter Merchandising Department to manage the strategic regular (non-promotional) prices for the entire organization. Even though they are merchandising systems the results impact the entire organization.

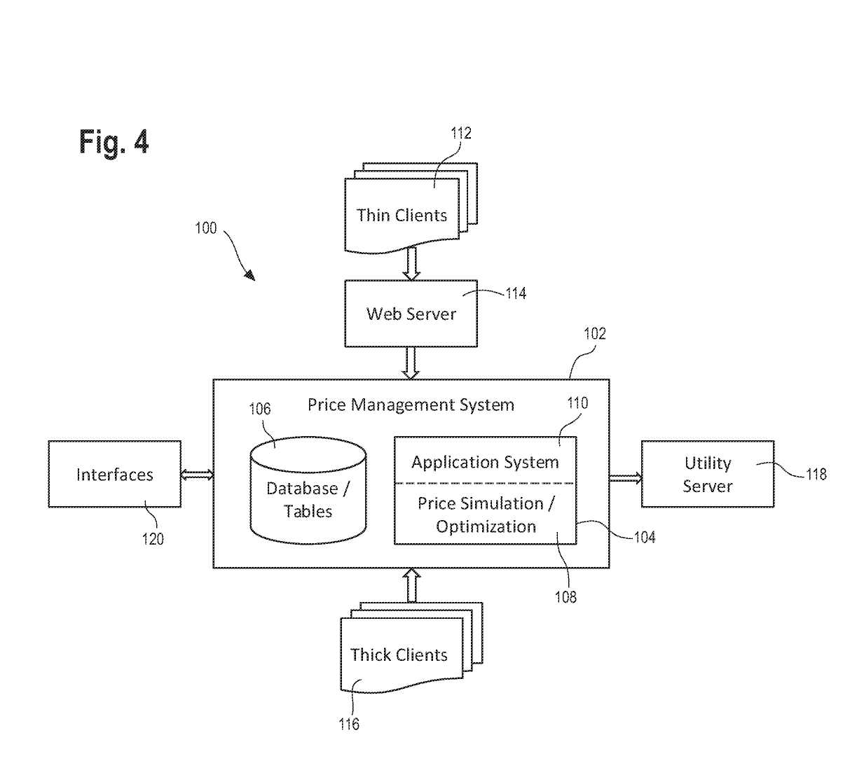

Turning to FIG. 4, an apparatus 100 in one example comprises a price management system 102 which includes at least a processing unit 104 and memory 106. Processing unit 104 executes instructions to control many functions of price management system 102, including, for example, an operating system, memory management and interfaces with external systems. In particular, processing unit 104 executes price analysis and optimization software 108 for developing a pricing strategy, and an application system 110, which maintains and communicates prices to stores on a periodic basis, among other functions.

Memory 106 stores information necessary to the functioning of price management system 102, including a variety of databases and tables which will be described in more detail below.

Price management system 102 can be accessed a variety of ways, including by thin clients 112 through a web server 114, or by thick clients 116, which typically have more internal processing power than thin clients 112. A utility server provides for summary tables for third party providers (including retailers) to access key summary information for additional processing (reports, analysis, interfaces, etc. Finally, interfaces 120 allow price management system 102 to communicate with point-of-service terminals and registers, for example. In a further embodiment, interfaces 120 provide to outputting pricing information to a printer for printing labels or to an RFID or wireless network for communication with electronic shelf labels (ESLs).

Application system 110 includes components for interfacing with various users of price management system 102. Employees can view and manage pricing events and rules and relationships that impact pricing decisions. Warning and error messages can be viewed and addressed through application system 110 and the results of pricing analysis are displayed. Application system 110 also manages interactions between system 102 and external systems, for example, retrieving cost and competitive pricing information and exporting/importing prices and other data.

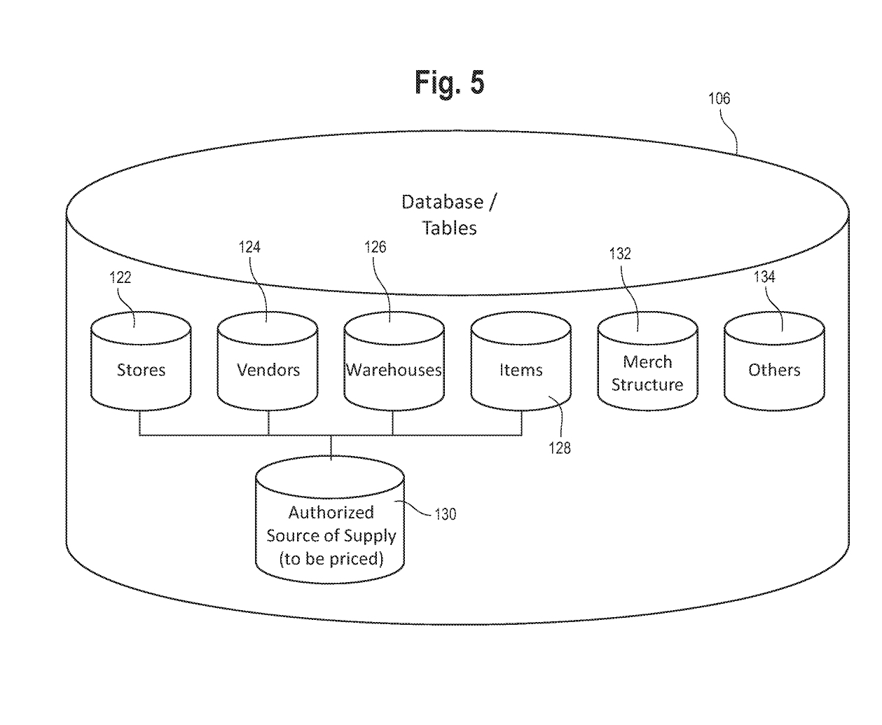

A more detailed view of memory 106 is shown in FIG. 5. There are many databases and tables that store the required information for strategic price analysis and optimization. In an embodiment, the databases are relational databases but any type of database may be used. Database 122 represents information about stores, including formats, zones and merchandising hierarchy. Database 124 represents information about vendors, including stores, items, cost and warehouse. Database 126 represents information about warehouses, for example, stores, items per pack and cost per vendor. Database 128 represents information about items themselves, for example, their description, size, UPC/PLU, pack and price group. Databases 122-128 are closely related and are summarized by table 130, an authorized source of supply, which is the table of items to be priced.

Additional information in memory 106 includes, for example, the merchandising structure of a retailer, including departments, categories, sub-categories, items and category managers in database 132. Database 134 includes information such as movement data (i.e. unit sales), competitive price information, market intelligence and factors used in pricing decisions. One of ordinary skill in the art would recognize that managing a retail operation with perhaps thousands of items in many different locations requires extensive and varied information to be retained and processed.

Various components of the system of FIG. 4 facilitate the function of price management system 102. For example, some of the processes and data stored provide for managing items, price groups and categories, and applying rules and relationships to any of these. Other tasks include managing displays and graphical user interfaces, calculating prices and other information according to the methods as described below, and managing all the various tasks that are part of a large software system.

Although representative examples of the functioning of the components of FIG. 4 have been given, one of ordinary skill in the art would recognize that the tasks described could be allocated to internal subsystems differently, and that additional related tasks could also be performed. Further, although an embodiment of the invention is focused on regular “every day” pricing decisions, the invention applies equally to a wide variety of pricing decisions, for example, sales, frequent shoppers and target customers.

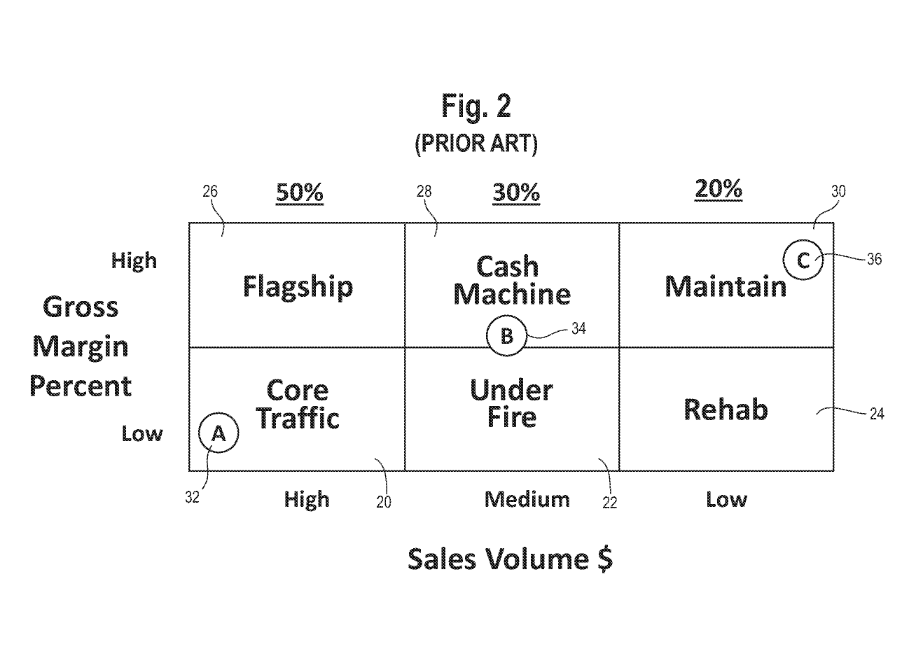

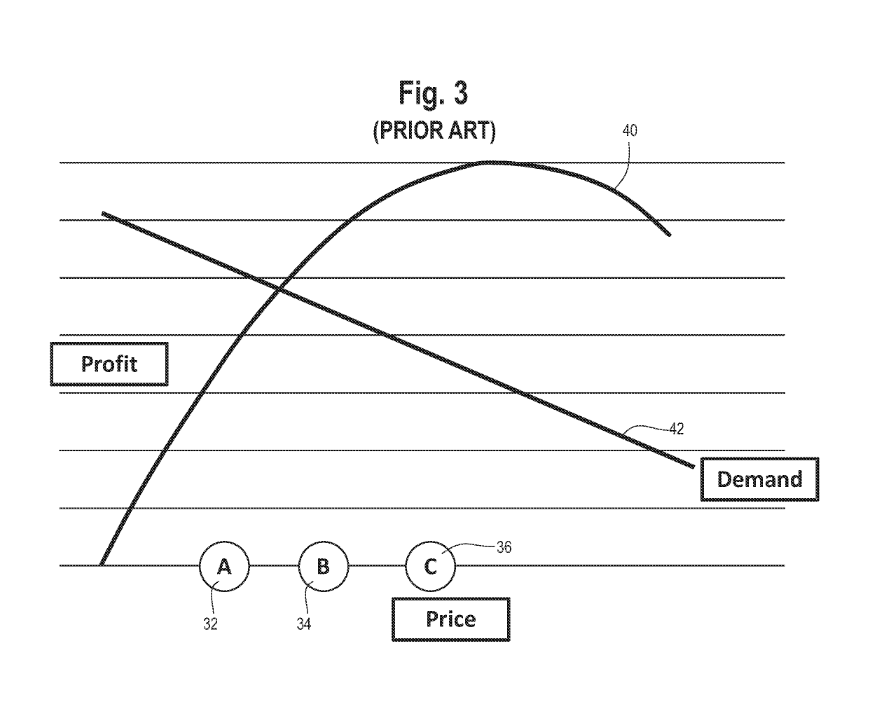

As explained above, the matrix of FIG. 2 provides a way to divide the hundreds to thousands of items in a store or category into groups based on GM % and sales volume. Although this matrix gives useful insights, it does not address the challenge of determining a pricing strategy for items 34 between the extremes of low GM %, high volume items 32 and high GM %, low volume items 36. Although it would be possible to draw a straight line at any number of locations across the matrix, including between points 32 and 36, this provides an optimum profit for few, if any items.

In an embodiment, the invention comprises an iterative method for analyzing prices that involves drawing a curved line between items 32 and 36 on the matrix of FIG. 2. This curved line can then be manipulated by a user of the system to analyze changes in prices of items and the impact of those changes on GM % and profit. Although the discussion below is in terms of individual items, it could also be applied to various groupings of items.

A first step is to calculate the total sales for a set of items in a category according to the formula:

S₁=Σᵢ₌₁^{x}Qᵢ·Pᵢ, for all items x in a category (15)

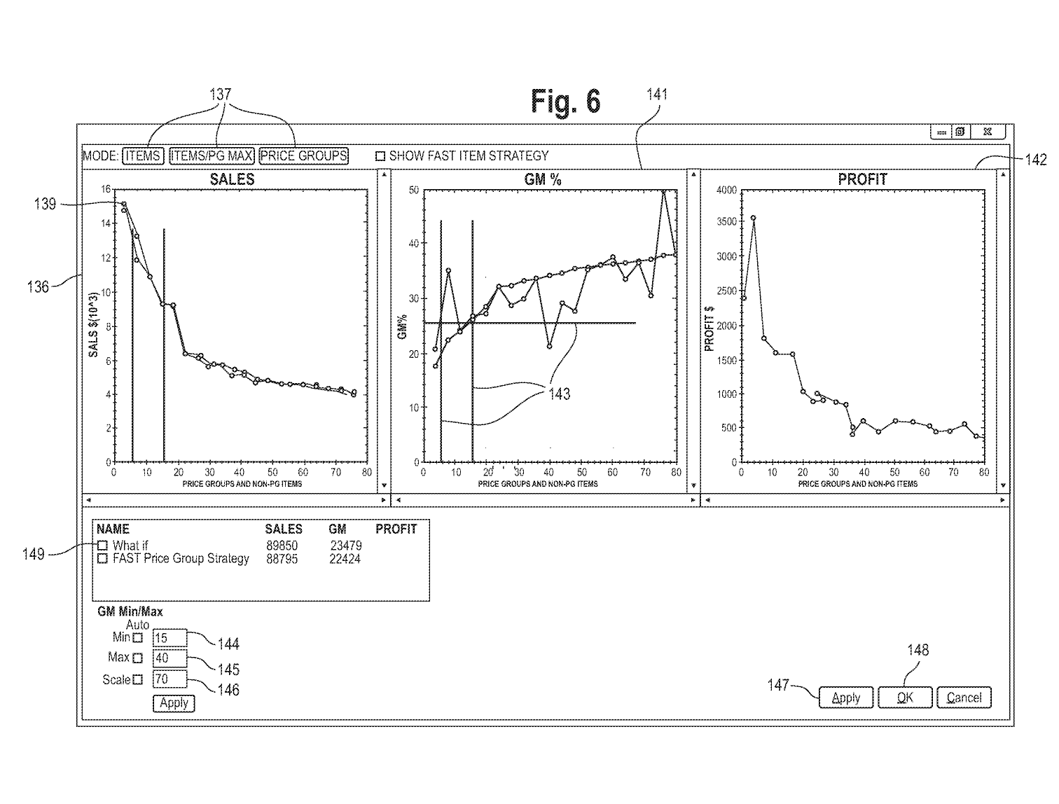

In a second step, the items are displayed in a graph of descending item sales indexed to the range between the max and min sales, as shown in FIG. 6 in window 100. Each circle shown, for example, at 102 in the graph represents an individual item. In an alternative, each circle represents what is known as a price group, which is a group of items which have the same size and manufacturer, but different flavors, for example. Usually, items within a price group have the same price. In an embodiment, a user may select between displaying the graph according to items or price groups using mode buttons 108.

The items in window 100 are listed from the item 104 with highest sales to item 106 with the lowest sales.

In a third step, a graph of GM % between minimum and maximum values is calculated and displayed in window 110. The items, shown as circles for the starting prices, are plotted along the horizontal axis in the same order as shown in the sales graph of window 100. The minimum and maximum values of GM % can be selected by a user, for example, a typical minimum value would be 15% GM % and a typical maximum would be 40% GM %. For this step, a GM % is calculated for each individual item based on a mirror image of its index of the sales range. For example, item 104 with the highest sales is assigned to the minimum GM % while item 106 with the lowest sales is assigned to the maximum GM %. The remaining items are assigned a GM % based on their index of the sales range. A profit graph is shown in window 118.

In a fourth step, a new price for each item is calculated based on its assigned GM % that was calculated in the third step. Depending on the distribution of sales, the ordering of the items may change.

In a fifth step, a new total sales S₂ is calculated by using formula (15) with the same quantity but the new prices calculated in the fourth step. In addition to a new total sales figure, it is likely that the updated prices will result in a new ordering of items. In the current embodiment, the movement, or quantity sold, will be assumed to be constant. In an embodiment discussed below, the quantity sold will be a function of Elasticity and the Demand Model.

In a sixth step, a delta sales is calculated, S₂−S₁=ΔS

In a seventh step, it is determined whether or not ΔS<δ, a threshold selected by the user, for example $1.00 or $0.01. If ΔS>δ, then the method returns to the second step and repeats with the new descending item sales index.

If ΔS<δ, the iterative process is done and prices have a starting guideline to optimization so as to achieve Sales, GM %, Profit, and Competitive Price Indices objectives and goals. To further enhance a user's understanding of the price simulation, the Category Matrix of FIG. 2 is superimposed on the GM % graph 110 of FIG. 6 through the use of grid lines 111. A final graph of items versus sales and GM % are shown in windows 100 and 110 as squares in FIG. 6.

Although particular graphs are shown in FIG. 6, these are for illustration purposes and one of ordinary skill in the art would understand that any set of items or price groups could be shown. As explained above, minimum and maximum GM % values can be chosen in fields 112 and 114. The displays in windows 100 and 110 can also be fine-tuned through the use of Scale field 116. A Scale Factor would be applied as a last calculation in the third step to each respective item index value. A value of 100% would give the graphs shown in FIG. 6. A value of 0% would result in a straight line between the min and max values.

### Second Embodiment

The first embodiment disclosed above assumes that the elasticity, or movement, remains constant through the simulation method steps. In a second embodiment, a user can chose a dynamic elasticity demand. In addition, either of the first or second embodiments can be calculated using different sales dollars variables. For example, the total dollars in sales can be for Price Groups instead of for single items, or can be based on the fastest moving item in the Price Group.

After completing either of the first or second embodiments, the simulation results can be moved into a “what if” partition as shown in FIG. 6 through the use of Apply button 120 or Go button 122. Then further pricing simulation can be performed with other considerations, for example, Price point rounding, Spreads, Parity, Competitive reaction, Key Value Items (KVI), Market share, Targeted price points, Optimal Profit Price, and Optimal Revenue Price.

A further variation on either of the first or second embodiments involves locking the price or one or more items or price groups prior to beginning the simulation method. In this variation, the locked price point overrides the item value but the rest of the items in the category follow the simulated curves. This, at times, gives a better (more realistic) starting point for the initial evaluation of the performance measures.

In yet another variation, either method of the first and second embodiments may be used to analyze additional groups of items, for example, categories in a department.

### Third Embodiment

In a third embodiment, system 100 provides a method for analyzing Price Groups. While system 100 provides all the standard spreadsheet measures for both Items and Price Groups for developing a pricing strategy, in the Price Group view of the third embodiment four important measures are also shown:

1. Number of items in a Price Group

2. Total sales dollars (revenue)

3. Average Item sales dollars

4. Fastest Item sales dollars (Max Item)

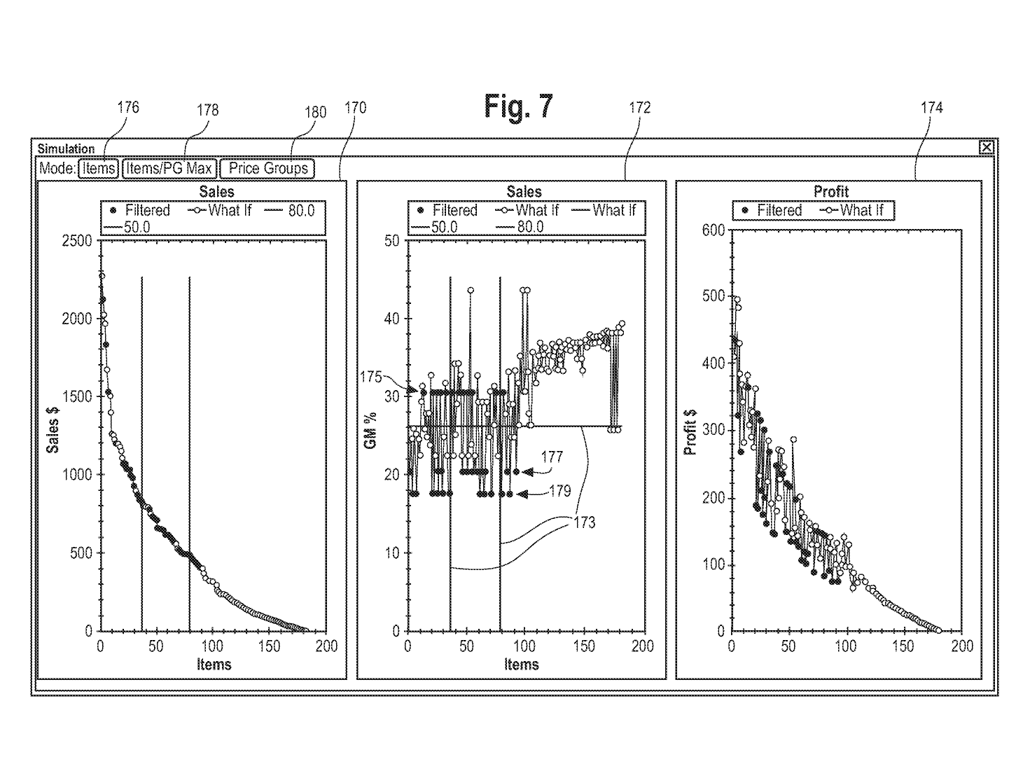

All these must be considered as well as the “distribution” (sales range) of the items in a Price Group. Depending on the circumstances each variable (and sometimes pairs) is the crucial decision variable. Prices may be analyzed using a graphical view as shown in FIGS. 7, 8 and 9 of Sales in window 130, Gross Margin % in window 132, and Profit in window 134, in descending items sales sequence with dimensions of Items, Max Item in Price Groups (and single Items), and Price Groups (and single Items), respectively. As described above, the six cells of the Category Management Matrix are shown window 132 as represented by lines 133. These graphs and dimensions provide significant insights in developing pricing strategies. Although FIGS. 7-9 are described in terms of a specific category and items, this is for illustration purposes only.

In FIG. 7, all items in a category are displayed as indicated by selected button 136. The filled in circles represent items that have been filtered for Price Groups of Ragu at 139 in window 132, Prego at 137 and Classico at 135 in the Spaghetti Sauce Category. In an embodiment, hovering over a dot will display a pop-up field with the name of a specific item. This display shows the dispersion of items in their respective price groups, as well as the relationship to the other groups. For example, in FIG. 7, Classico has the densest assortment while Prego is the most dispersed with both the fastest moving item and the slowest moving item.

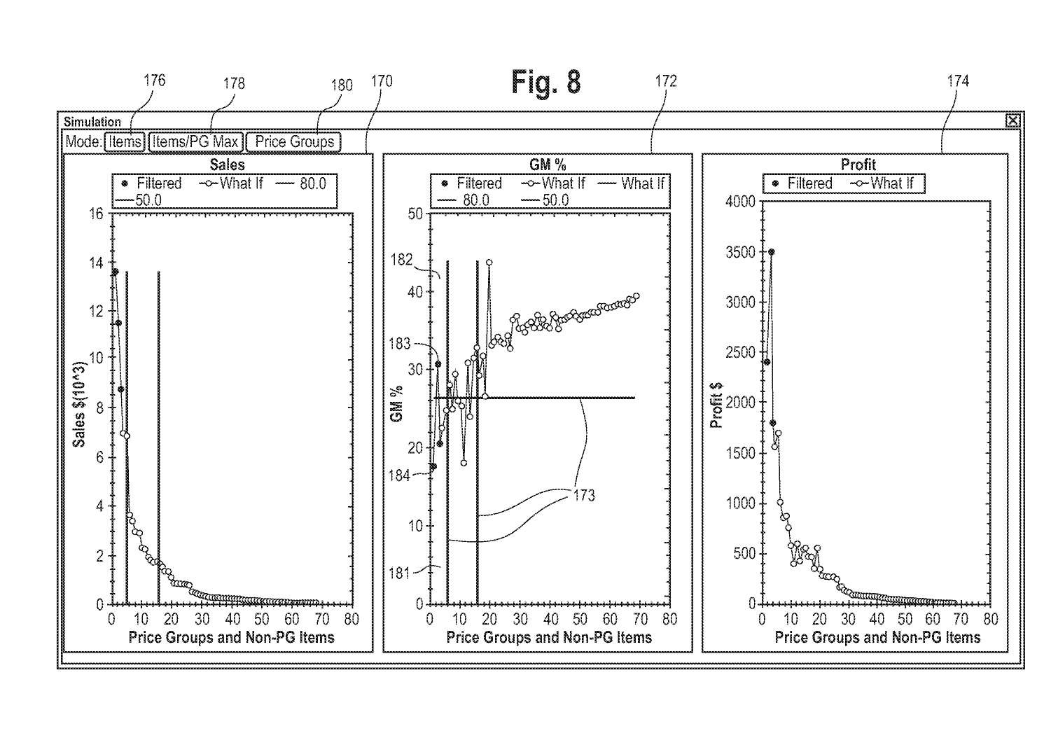

Additional insight is given by FIG. 8, which shows the same display as FIG. 7, with Price Groups button 140 selected. This provides insight into how the various Price Groups relate to the Category Management Matrix of 2. In this example, the three selected groups are the fastest selling groups. They are in the Category matrix sections of 141 and 142 (corresponding to 20 and 26 in FIG. 2). However, the second group 143, Classico, has a significant higher gross margin and is in the Flagship Role while the other two are in the Core Traffic Role. For Ragu the fastest moving group 144 has the lowest gross margin. This is consistent with pricing principles but there are exceptions and other dimensions will give other perspectives. It is this view that helped determine that Ragu would have the lowest gross margin.

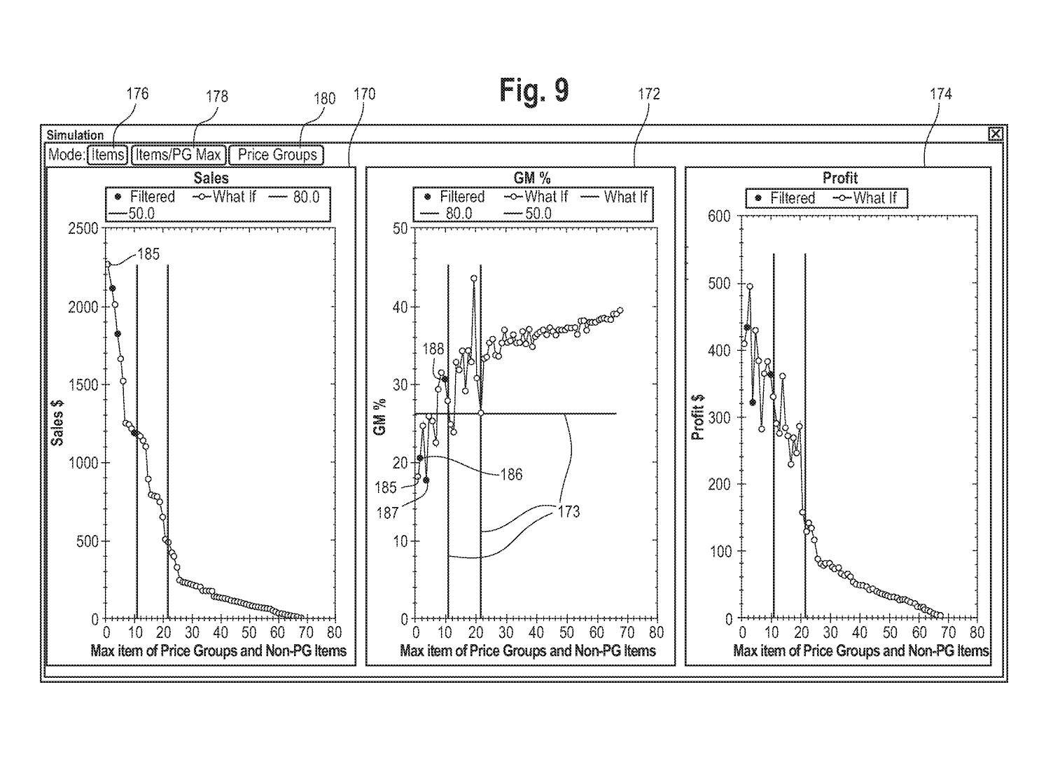

The three view display of FIG. 9 also provides insights into pricing the Max Item in each Price Group as shown by the selection of button 138. We see first of all the fastest moving item 145 in window 130 in the Category is not in the three fastest moving Price Groups indicated by the filled in circles. Also the fastest moving item 145 in window 132 in the Category is not the lowest gross margin (though close). Between Ragu and Prego, the fastest moving Max Item 146 is Prego, but with a higher GM % (20.5%) than Max Item 147 for Ragu GM % (17.6%). In this case we were more influenced by the Price Group than the Max Item.

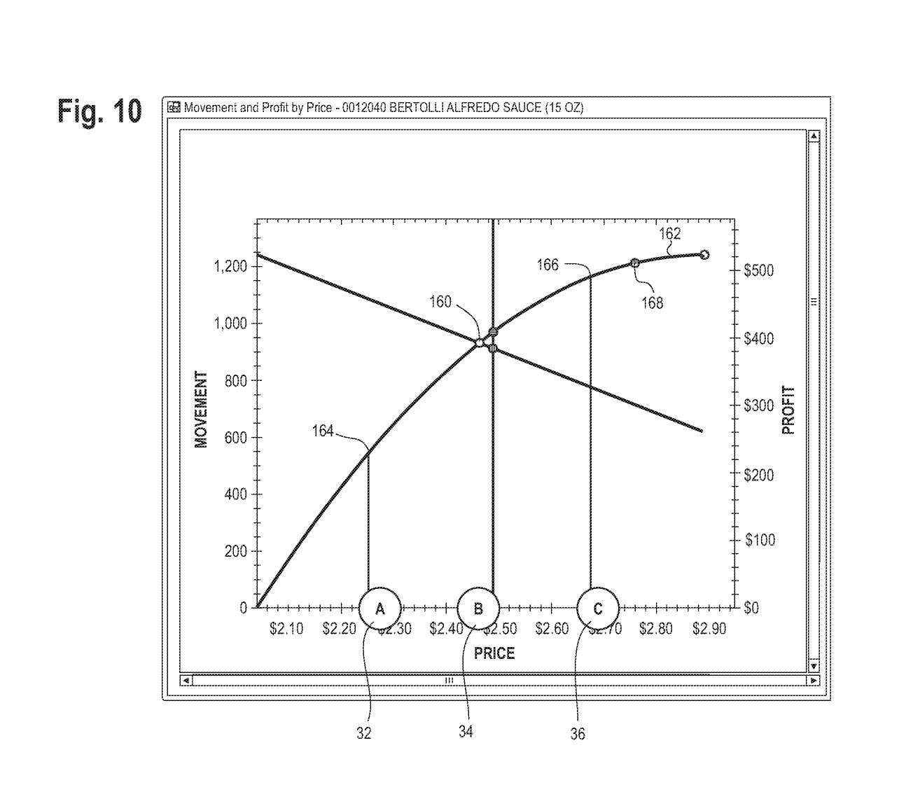

Note Classico's Max Item 148 is significantly slower moving than the other two Max Items and has a higher gross margin percent. It is in this view that we choose Classico to have a significant higher GM % even though the Price Group was the second fastest selling Price Group. See FIG. 10 One final note the main reason for Classico being the second fasting selling Price Group is due to the number of SKUs (Stock Keeping Units) in the Price Group.

### Fourth Embodiment

In a fourth embodiment, the invention comprises a system and method for determining a price that balances profit and price image (competitive position). Equation (16) gives the optimum profit price in terms of price, cost and elasticity:

P_{opt profit}=(C+P·(ε−1)/ε)/2 (16)

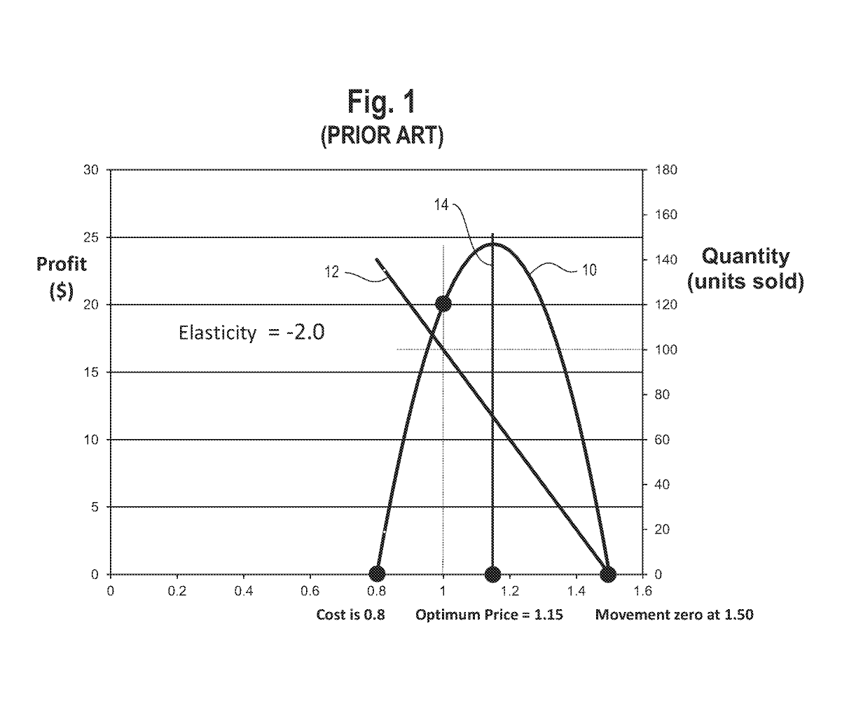

A profit curve and optimum profit price for a specific example is shown in FIG. 1 and discussed above. From a practical point of view, a price that balances profit and price image is somewhere between the cost of the item and the optimum profit price. In the fourth embodiment, the invention comprises determining a Balance Point 160 on the profit curve 162 as shown in FIG. 10.

There are three ways of calculating the Balance Point 160 using the Ratio demand model described above. First the differential slope of the profit curve at both price equal cost and price equal optimum profit is calculated, and then the price on the profit curve where the differential slope is equal to the average of the two extreme slopes is determined. Second, the algebraic slope between the price at cost and optimum profit of the profit curve is calculated, and then the price on the profit curve where the differential slope is equal to the algebraic slope is determined. The third method is simply averaging the cost and the optimum profit price.

As a further note, the second way of calculating a balance point can be used for all appropriate demand models. In general, any of the above methods, when used with the Ratio demand model, will determine the Balance Point 160 price according to the following formula:

In further alternatives to the third embodiment, a range of Balance Point prices can be determined. For the competitive focus (price image) Balance Point 164 we use a “normalized” slope of 1.5>1.0 with formula (18). This would be useful, for example, for determining prices in group 32 of FIG. 2.

P_{Balance Point Competitive (Full)}=⅞·C+⅛·P·(ε−1)/ε (18)

For the profit focus Balance Point 166 we use a “normalized” slope of 0.5<1.0 with formula (19). This would be useful, for example, for determining prices in group 36 of FIG. 2.

P_{Balance Point Profit (Full)}=⅝·C+⅜·P·(ε−1)/ε (19)

For the competitive focus (price image) Balance Point midway between 160 and 164, we use a “normalized” slope of 1.25>1.0 with formula (20).

P_{Balance Point Competitive (Mid)}= 13/16·C+ 3/16·P·(ε−1)/ε (20)

For the profit focus Balance Point midway between 160 and 166, we use a “normalized” slope of 0.75<1.0 with formula (21). Formulas (20) and (21) would be useful for determining a tighter range of prices.

P_{Balance Point Profit (Mid)}= 11/16·C+ 5/16·P·(ε−1)/ε (21)

### Fifth Embodiment

This embodiment involves the determination of prices that have a profit elasticity of 1. This price is defined as the price, PE=1 at 168 in FIG. 10, so that if the price is increased x % (1%), the profit will be increased less than x % (1%). And if the price is decreased x % (1%), the profit will be decreased greater than x % (1%). The formulas for PE=1 are:

P_{PE=1}=√(C·P·(ε−1)/ε), for Ratio (Straight Line) demand model (22)

P_{PE=1}=C·(α−1)/α), for Exponent (log/log) demand model (23)

This embodiment is useful, for example, for determining a highest price for items in group 36 of FIG. 2.

### Sixth Embodiment

In this embodiment, additional methods of calculating and displaying pricing information to a user of system 100 are provided. FIG. 10 illustrates a representative display.

The display of FIG. 10 would be used in the following scenarios:

Scenario A at 32, how low should the item be priced? The factors to consider include Cost, BP-Competitive Full Range from formula (18) and BP-Competitive Mid-Range from formula (20). The guidelines for decisions include whether P=Cost (zero profit—too low), BP-C Full (goal area for true KVI items) and BP-C Mid (goal area for important items).

Scenario B at 34, how is the item priced in the middle range? For this pricing strategy, BP 160 from formula (17) is a target area.

Scenario C at 36, how high should the item be priced? The factors to consider are Optimal Profit Price from formula (7), (8) or (9), PE=1 from formula 22 or 23, BP-Profit Full Range from formula (19) and BP-Profit Mid-Range from formula (21). The guidelines for decisions include whether the Optimal Profit Price is too high (diminishing return), PE=1 as the highest price, and BP-P as a good target area.

Decisions can get even more complicated. Consider just two examples: A category has a Role of Core Traffic but an item is Maintain. Where should the item be priced on the profit curve and vice versa? A further example is: A store is very competitive but the category is Maintain and the item is Under Fire. Where should the item be priced on the profit curve?

There can be hundreds of combinations but at the end of the day a decision has to be made on the price for every item in every store. Analytic guidelines help the pricing professional have a decision process structure.

For the Ratio Method the Analytic Measures are a function of Price, Cost and Elasticity. For changes to Price we can see where we stand relative to the Analytic Measures values as well as Profit. Any changes to Cost and Elasticity will change the shape of the Profit Curve and as a result will impact the Analytic Measures. Analytic Measures impacted will be:

Balance Point—Competitive

Balance Point

Balance Point—Profit

Profit Elasticity=1

Optimum Profit Price

The Graphical User Interface provides the user with a better visualization of the impact of price changes as well as providing all the related calculations. Also note that Competitive Prices are also available for consideration in the final decision.

Any changes in Price can then be applied to the spreadsheet of the Simulation.

### Seventh Embodiment

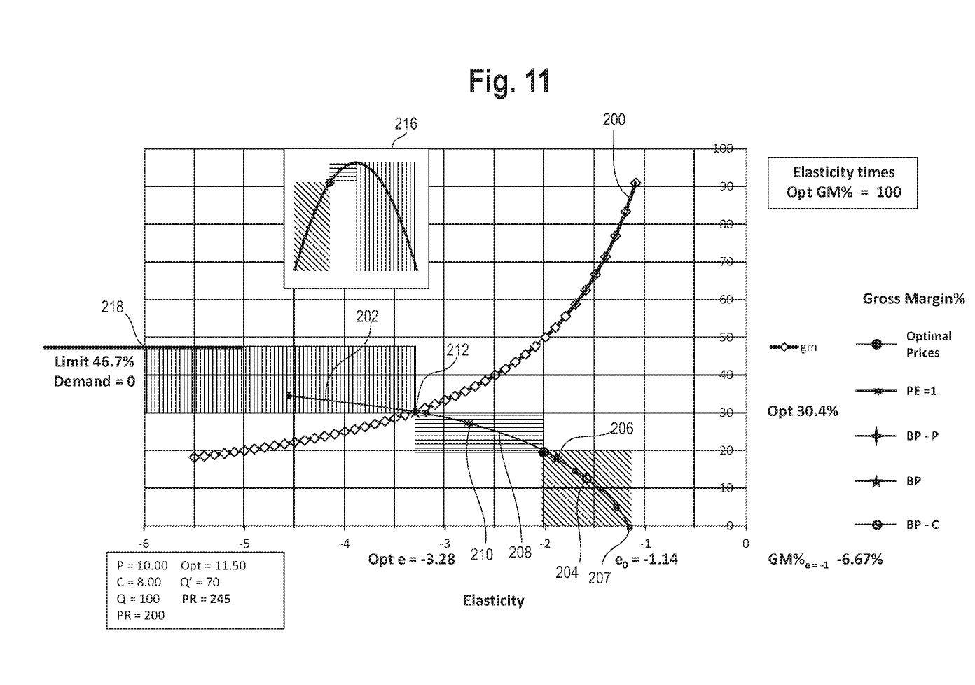

In this embodiment, the system and method of the invention encompasses simulating and optimizing prices using a universal optimization chart as shown in FIG. 11. Several analytic measures for determining prices have been described above, including Balance Point Price, Balance Point Ranges Price, and Profit Elasticity=1. However, these measures have been discussed with regard to a single item or price group with specific values for price, cost, movement and elasticity, as shown in FIGS. 9 and 10, for example. In order to compare multiple different items in a category, it is valuable to have common denominators for the X and Y axes for all items. A logical graph for performing this analysis plots elasticity and GM % in the universal optimization chart of FIG. 11.

FIG. 11 shows curve 200 as the Optimum Prices for a single item plotted as a function of Elasticity on the X axis and GM % on the Y axis. Curve 202 represents the item profit curve with dimensions of elasticity and GM %. Curve 202 is plotted using formula (24):

$$GM ( ɛ , {ɛ}_{0} , {GM}_{0} ) = \frac{ɛ \cdot ( 1 - {ɛ}_{0} {GM}_{0} ) - {ɛ}_{0} \cdot ( 1 - {GM}_{0} )}{ɛ \cdot ( 1 - {ɛ}_{0} )} \qquad ( 24 )$$

There are two extreme points that are important. One is the elasticity when GM=0 at point 207 and the other is the GM limit as elasticity increases without bound, i.e, as ε approaches infinity at point 218. These extreme points are handled as follows. The GM=0 coordinate 207 with Elasticity is useful to simplify calculations. Also when we consider Revenue it will be important to know what is the value of Elasticity when GM=0. Key Elasticity values are −2.0, −1.0, and −0.5. The value is given by the formula:

ε(GM=0,ε₀,GM₀)=(ε₀·(1−GM₀))/(1−ε₀GM₀) (25)

The second extreme point 218 for Gross Margin as elasticity increases without Bound is given by the limit formula:

GM(ε=−∞,ε₀,GM₀)=(1−ε₀GM₀)/(1−ε₀) (26)

Referring to FIG. 11, point 206 indicates the Balance Point for this particular item. Point 204 indicates the Balance Point—Competitive, point 208 indicates the Balance Point—Profit while point 210 indicates the point where Profit Elasticity=1. Point 212 indicates the Optimum Profit on curve 200.

A representation of the profit curve of FIG. 1 is shown in inset 216 of FIG. 11. Shaded areas in the inset correspond to the same shaded areas on the main graph.

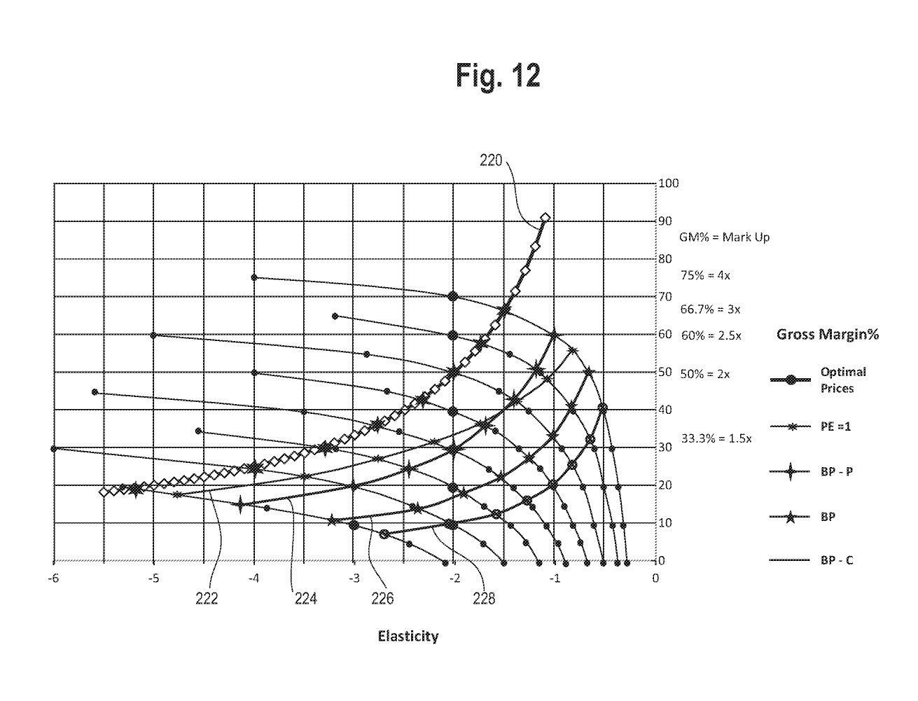

The Universal Optimization Chart for a plurality of items is shown in FIG. 12 The Optimum Price curve 220 is called a frontier since pricing beyond this curve has reduced profit as the price (GM %) increases. The following equations generate the curves on the chart of FIG. 12. The equation for Gross Margin as a function of Elasticity of the Balance Point Price curve 226 for the Ratio Method of Elasticity is

GM_{BP}(ε)=−1/(3·ε), for ε<−0.3333 (27)

The equation for Gross Margin as a function of Elasticity of Balance Point—Competitive (Full) Curve 228 for the Ratio Method is

GM_{BP}(ε)=−1/(7·ε), for ε<−0.143 (28)

The equation for Gross Margin as a function of Elasticity of Balance Point—Profit (Full) Curve 224 for the Ratio Method is

GM_{BP}(ε)=−3/(5·ε), for ε<−0.6 (29)

The equation for Gross Margin as a function of Elasticity of Balance Point—Competitive (Mid) Curve for the Ratio Method is

GM_{BP}(C)=−3/(13·ε), for ε<−0.231 (30)

The equation for Gross Margin as a function of Elasticity of Balance Point—Profit (Mid) Curve for the Ratio Method is

GM_{BP}(ε)=−5/(11·ε), for ε<−0.4545 (31)

The equation for Gross Margin as a function of Elasticity of Profit Elasticity=1 Curve 222 for the Ratio Method is

GM_{PE=1}(ε)=−1/(ε−1), for ε<0 (32)

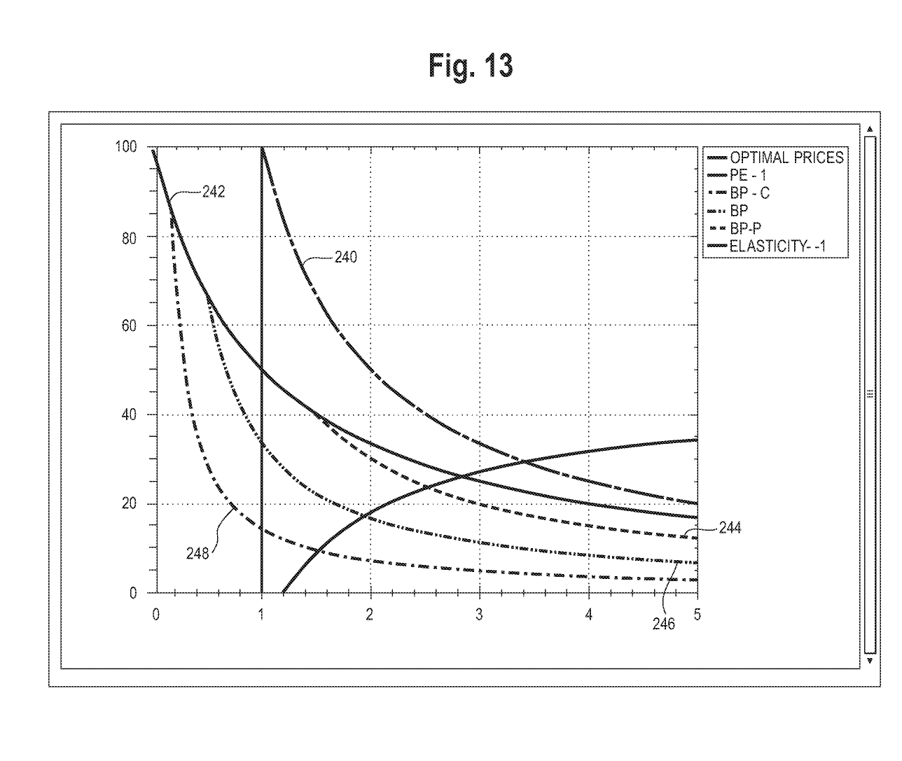

FIG. 13 illustrates a user display of the Universal Optimization Chart (UOC) of FIG. 11 in the system of FIG. 4. In this display, an absolute value of elasticity c is used. This provides a more comfortable viewing experience for a user and improves the functionality of the system. The chart of FIG. 13 provides a common denominator view of the Profit Curve with the axes of Elasticity and Gross Margin. All items in a category have these common dimensions and the UOC enables one or more items to be viewed on the common dimensional chart with lines or “guard rails” of the Analytic Measures of Optimum Profit Price shown by curve 240, Profit Elasticity=1 shown by curve 242, Balance Point—Profit shown by curve 244, Balance Point shown by curve 246, and Balance Point—Competitive shown by curve 248.

### Eighth Embodiment

In an eighth embodiment, the system and method encompasses further user interfaces for analyzing and determining prices for consumer goods. A combined display of FIGS. 10 and 13 will be shown along with the quantitative measures of the Analytic Measures described above. The quantitative measures are Price, Unit Profit, GM %, Movement, Sales, Profit and Elasticity. An example of quantitative measures as correlated to UOC analytic measures is given by Table 4:

| | Spreadsheet - | | Optimal | | | Price | Profit |
|---|---|---|---|---|---|---|---|
| | What If | What If | Price | PE = 1 | BP | Emphasis | Emphasis |
| Price | $2.99 | $2.99 | $3.89 | $3.45 | $2.999 | $2.53 | $3.44 |
| Unit Profit | $0.91 | $0.91 | $1.81 | $1.37 | $0.91 | $0.45 | $1.36 |
| GM | 30.43% | 30.43% | 46.53% | 39.64% | 30.37% | 17.90% | 39.54% |
| Movement | 399.4 | 399.4 | 267.1 | 332.4 | 399.8 | 466.4 | 333.2 |
| Sales | $1194.12 | $1194.12 | $1039.16 | $1145.40 | $1194.23 | $1181.73 | $1146.29 |
| Profit | $363.43 | $363.43 | $483.52 | $453.98 | $362.64 | $211.54 | $453.30 |
| Elasticity | −1.100 | −1.100 | −2.140 | −1.523 | −1.098 | −0.798 | −1.517 |

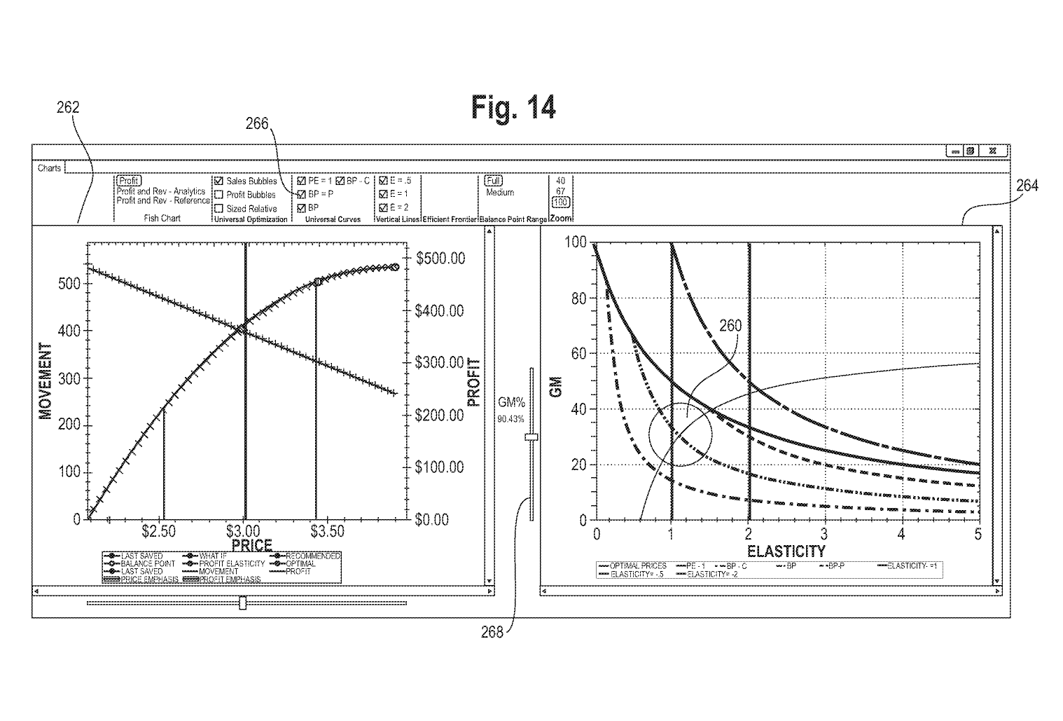

The table above is corresponds to the Profit Curve of FIG. 10 and the UOC of FIG. 1e3 as shown in FIG. 14 at 262 and 264 respectively, which shows Profit Bubble 260 for a price of $299, GM % of 30.43% and elasticity of 1.1. This corresponds to the What If scenario in the first column of the above Table. Profit, or Sales, Bubble 260 represents the relative size of the measure for the respective amounts for the item(s) Profit Curve(s). This display is selected by checking box 266.

In further embodiments, Profit and Sales Bubbles can be shown with respective proportional values for several different conditions corresponding to the other columns in the table above. In additions, up to three items can be viewed on the UOC, with options to include the Sales and/or Profit Bubbles to show the respective proportional values.

In a further embodiment, a slider bar 268 in FIG. 14 is provided so a user can dynamically change the curves of both windows 262 and 264, changing the sizes of bubbles and the quantitative values in the table above. The “real time” changes allow more in depth analysis of the impact of price changes.

In a further embodiment, when an item has been selected for UOC display as shown in FIG. 14, there is an option to see the corresponding Price Group with the same GM % but the elasticity of the Price Group is the weighted average of the elasticities for all the component items of the Price Group. The chart in window 262 will be shown for either the highlighted Item or Price Group. Similarly the Quantitative Measures of the Analytic Measures will be for the highlighted Item or Price Group. The Sliding Scale will be for the highlighted Item or Price Group. All Options are available including changing Item, Price Group or Both.

In yet another embodiment, when a Price Group is selected for display in the UOC in window 264, there is the option to also display its component Items. Note the GM % will all be the same, but there will be different elasticity values for the Items. Since the initial selection was the Price Group, the chart in window 262 will be for the Price Group, but any item may also be selected. While the UOC will allow up the three Price Groups, when the Item components are chosen, there can be only one Price Group selected.

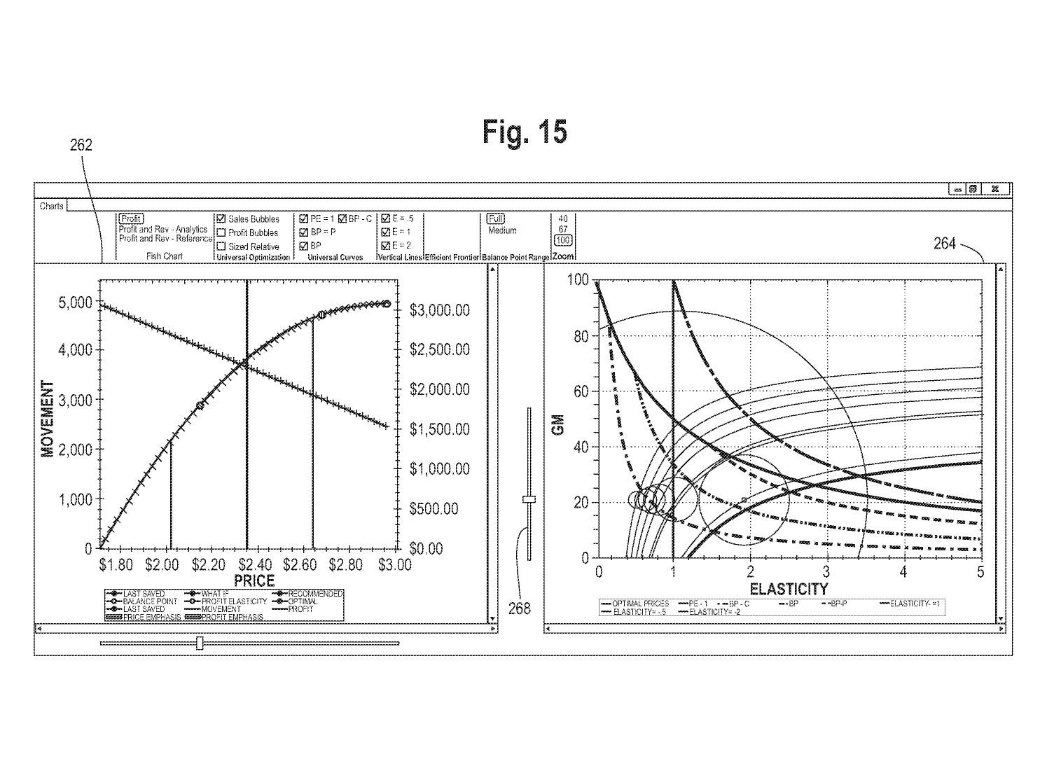

The important observation in example shown in FIG. 15, which is represented as Prego 280Z, is that except for the Max Item, the remaining component items all have elasticity values equal to or less than that of the Price Group. This creates a challenge in determining the price for the Price Group as well as comparing to other competitive brand Price Groups. We can see the spread in FIGS. 7-9 but it is not as dramatic since the X axis of FIGS. 7-9 is Item Count, but for FIG. 15 the X axis is Elasticity and proportional to Sales. UOC uniquely provides this insight.

### Ninth Embodiment

It can be shown that for KVIs (Key Value Items) with competitive prices and low GM %, elasticity values are not a key factor in profitability. However, elasticity does exist and is still important particularly when we consider the Analytic Measures discussed above: Optimum Profit Price, Profit Elasticity=1 and Balance Point prices.

The problem is elasticity, E, for regular (base) price is a difficult statistic to calculate appropriately and is a very inaccurate measure when compared to the decisions of individual customers. It is an “average” of a tremendously large variety of decision making that has significant error relative to the demand model projections. There is data that has a positive slope pattern which, of course, statisticians throw out; but never the less is real.

It is a general truism (but always exceptions) that fast moving more competitive items will be more price sensitive (high—absolute sense—elasticity value). Slower moving and unique items will be less sensitive. If −1.0 (1.0 absolute) elasticity is considered the “tipping point” between sensitivity and non-sensitive, then the vast majority of the items are not sensitive.

A system and method has been disclosed that will provide for the determination of “analytic elasticity” values following the general truism. These values can be used for all the analytic measures and demand calculation using elasticity. Of course if statistically accurate and reliable elasticity values are available for selected items, then they could be used as “override” values for the “analytic elasticity” values.

Analytic Elasticity is a direct function of the declining sales volume curve of the items in a category (sub-category) for a selected zone or group of stores. Analytic Elasticity can be calculated for all items in the Category by using a curve in proportion to the items declining sales but constrained to Min Elasticity, Max Elasticity and Scale values. The methodology is very similar to the method of the first embodiment by replacing Max, Min and Scale, with the exception that Analytic Elasticity is directly proportional to declining sales as opposed to the inverse relationship for the first embodiment. The analytic values will be directly proportional to declining items sales bounded by the Min/Max Elasticity values with the curve shaped by the scale factor.

### Tenth Embodiment

In a tenth embodiment, the system and method of the invention encompasses a determination of optimum revenue, specifically, profitable optimum revenue. This analysis is important since one can be near the top of the revenue curve and be at negative profit. In fact, optimum revenue may not be the best strategy given the profit loss to achieve the optimum. There is an alternative target and that is Revenue Elasticity=−1. This is the price where there is diminishing rate of revenue increase for reducing the price. This is comparable to Optimum Profit and Profit Elasticity=1.

For high margin items and items with low elasticity the revenue will be profitable. And as we will see the current price is near the optimum revenue. In fact, if E=−1.0, then current price is at optimum revenue.

The real challenge with Optimum Revenue and even Revenue Elasticity=−1 is for fast moving, sensitive, and competitive items. When there is the strategic emphasis on revenue, the pricing professional will need to carefully evaluate the profitability. The tenth embodiment makes use of the Ratio (Straight Line) model. Based on equation (4), Revenue Rₙ at price Pₙ is given by:

Rₙ=Pₙ·Qₙ=Pₙ·Q₀·(1+ε·(Pₙ−P₀)/P₀) (33)

and the price of Optimum Revenue is

P_{OptRev}=½·P₀·(ε−1)/ε (34)

An analysis of the above formulas reveals that optimum revenue always occurs when ε=−1.

By definition, the slope of the revenue curve at the optimum revenue price is 0.0 in the absolute and “normalized” sense. Near the top of the revenue curve the curve is flatter (slopes close to zero). Additionally, the optimum revenue price is less that the optimum profit price. A question can be posed as where is there diminishing revenue increases as the price is reduced. Therefore, Revenue Elasticity is defined as

Revenue Elasticity(RE)=Percent Change in Revenue/Percent change in Price

This is comparable to the definition of Profit Elasticity for the Ratio method. This results in a formula for price at RE=−1 of

P_{RE=-1}=⅔·(P₀·(ε₀−1)/ε) (35)

A further analysis shows that when RE=−1, ε=−2.0.

### Eleventh Embodiment

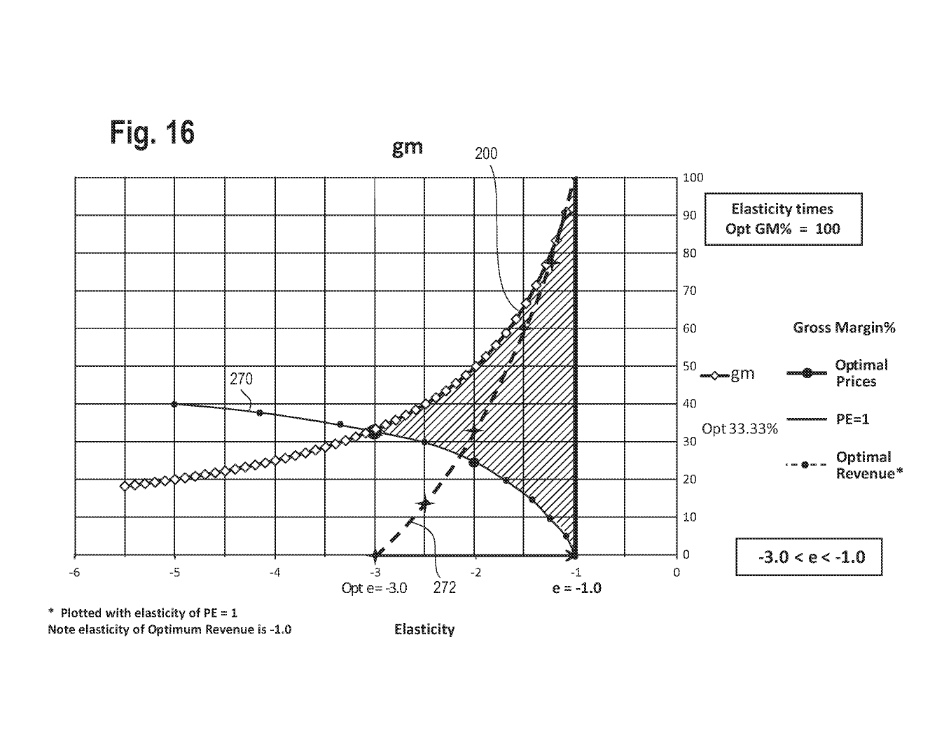

In an eleventh embodiment, the invention encompasses the determination of Efficient Frontiers. An Efficient frontier for an item is the set of prices between Optimum Revenue and Optimum Profit. As a starting point, the price of Optimum Revenue is always less than the price of Optimum Profit and the pricing decision reflects the “cost” for achieving optimum revenue. As a practical matter, the discussion is limited to the range where the profit of optimum revenue is greater than or equal to zero. This can be represented by the profit curve of formula (61). This is the lower bound curve 270 in FIG. 16 as given by the formula:

GM=(ε+1)/2ε for ε<−1 (36)

Referring to FIG. 16, Optimum Revenue is only feasible in the region of the UOC that is below curve 200 and above curve 270. Curve 272 is the formula for GM % of Optimum Revenue when at Optimum Profit and at Elasticity of the Optimum Profit as given by

GM_{Opt Rev@OPe}=(ε+3)/(1−ε) (37)

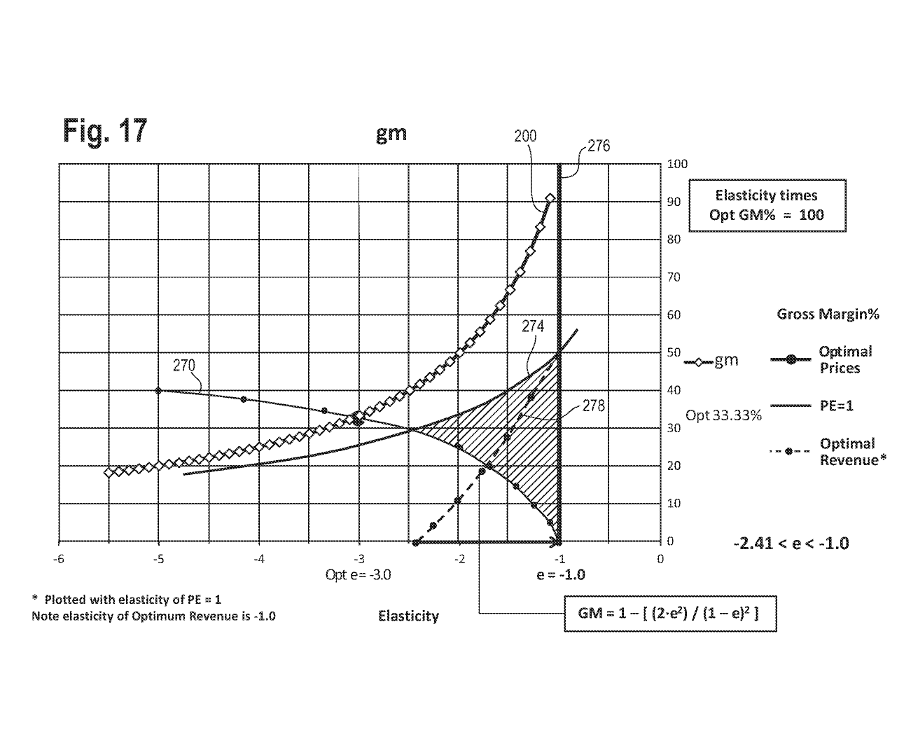

In a further embodiment, a Rational Efficient Frontier for an item is the set of prices between Profit Elasticity=1 (PE=1) curve 274 and the curve 270 of FIG. 17. The area of the Rational Efficient Frontier is the area constrained by the curves of Optimum Revenue at Zero Profit curve 270, PE=1 curve 274 and Optimum Revenue at E=−1.0 at vertical line 276.

In another embodiment show in FIG. 17, the invention encompasses a unique curve 278 of GM of Optimum Revenue when at PE=1. This curve is given by the formula:

GM_{Opt Rev @GM of PE=1}(ε)=1−((2·ε²)/(1−ε)²) for −2.4142<ε<−1.0 (38)

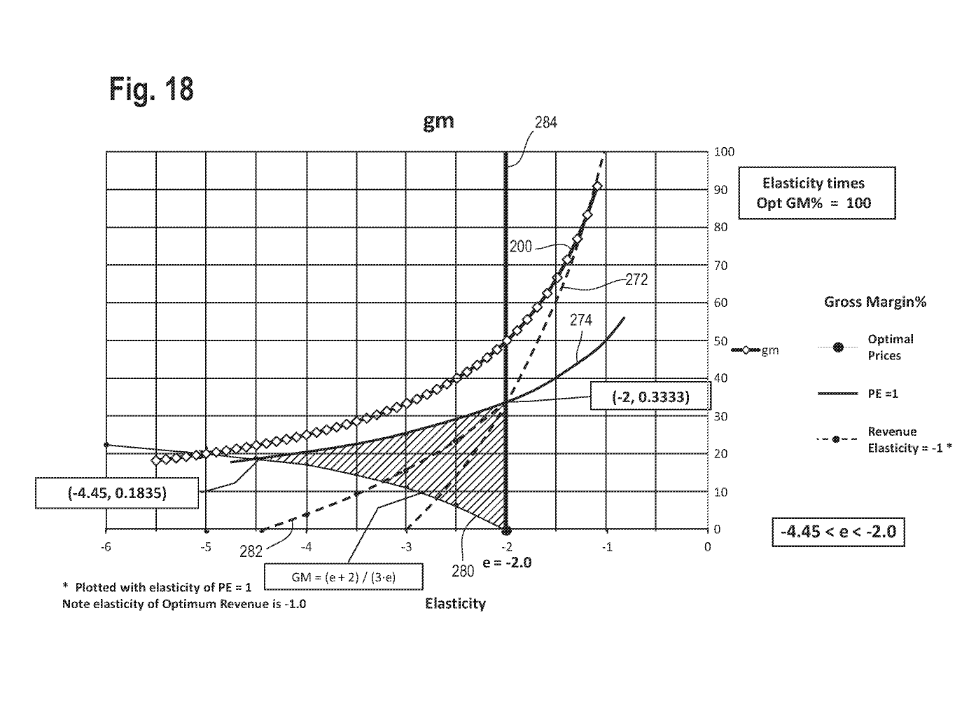

In a further embodiment as shown in FIG. 18, the invention encompasses the determination of an Efficient Frontier on the 1's for an item that is the set of prices between RE=−1 and PE=1. With very sensitive items with “high” elasticity values in the absolute sense, |ε|, then there is a need to expand the interpretation or view of Rational Efficient Frontier. As a starting point, there is a constraint of still being bounded by PE=1. However, the lower bound is expanded to be the profit curve when RE=−1 is at zero profit. That is, the profit curve defined by coordinates (−2.0, 0.0) on the Universal Optimization Chart. The formula for this curve 280 is

GM_{RE=-1 at Zero Profit}=(ε+2)/(3·ε) for −4.45≦ε≦−2.0 (39)

The domain of Efficient Frontier on the Ones (EF on 1s) is the area constrained by curves of Revenue Elasticity=−1 at Zero Profit (curve 280), PE=1 (curve 274) and Revenue Elasticity=−1 at ε=−2.0 (vertical line 284). This embodiment applies to items with high sensitivity which are also generally very important and fast moving items in the category. As a result, it is optimal to provide as much insight as possible in the final decision making. Thus, this embodiment further encompasses two guidelines that will provide insight into the final price decision making. The final decision with be based on the business objectives between Revenue and Profit. When RE=−1 and PE=1, curve 282 is given by:

GM_{RE=-1@PE=1}=1−((3·ε²)/2·(1−ε)²) for −2.4142<ε<−2.0 (40)

For Optimum Revenue when at Optimum Profit, curve 278 of FIG. 18 is given by:

GM_{OPT Rev@OPe}=(ε+3)/(1−ε) for ε<−1 (41)

As a further note regarding the guidelines for Efficient Frontiers where the emphasis in on Revenue and Profit, we emphasize the Profit Guidelines for balancing Profit and Price Image. That is, the guidelines for Balance Points which include Balance Point, Balance Point—Profit and Balance Point—Competitive in the context of Efficient Frontiers. The Balance Points guidelines give a different perspective since the objectives are profit and price image versus objectives of revenue and profit with regards to Efficient Frontiers. This is why it is necessary to emphasize the importance of Category Management and the setting of objectives and goals. Carefully defined objectives will direct the decision making processes.

The apparatus 100 in one example comprises a plurality of components such as one or more of electronic components, hardware components, and computer software components. A number of such components can be combined or divided in the apparatus 100. An example component of the apparatus 100 employs and/or comprises a set and/or series of computer instructions written in or implemented with any of a number of programming languages, as will be appreciated by those skilled in the art.

The steps or operations described herein are just for example. There may be many variations to these steps or operations without departing from the spirit of the invention. For instance, the steps may be performed in a differing order, or steps may be added, deleted, or modified.

Although example implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. A system for analyzing and determining prices of fast moving, long life cycle items in consumer package goods industries, said system comprising:
a plurality of point-of-sale terminals for generating unit sales data and storing it in a memory;
a computer processor operatively coupled to the memory for processing the unit sales data and associated unit cost data to generate graphs based on parameters of at least price, sales and gross margin percent (GM %);
a display for displaying the graphs to a user;
an input device for allowing a user to interact with the computer processor and display to change one or more parameters so as to determine a price for at least one unit; and
an output device for outputting new pricing information for the at least one unit.

2. The system of claim 1, wherein the unit comprises an individual item, a price group of related items, or a category of items.

3. The system of claim 1 wherein the output device further comprises a printer for printing labels indicating a price for the at least one unit, or an RFID or Wi-Fi network for outputting pricing information to electronic shelf labels (ESLs).

4. A computer-implemented method for analyzing and determining prices of fast moving, long life cycle items in consumer package goods industries, said method comprising the steps of:
receiving sales data for one or more items from a plurality of point-of-sale terminals;
receiving cost data for the one or more items;
analyzing, by a processor, the sales data and cost data to generate one or more graphs of sales and gross margin percent for a plurality of items or groups of items;
adjusting parameters in the one or more graphs to analyze prices of the one or more individual items or groups of items; and
outputting, by the processor, adjusted prices for the items.

5. The computer-implemented method of claim 4 wherein the unit comprises an individual item, a price group of related items, or a category of items.

6. The computer-implemented method of claim 4 wherein the step of outputting prices device further comprises printing labels indicating a price for the at least one unit, or sending pricing information over an RFID or Wi-Fi network to electronic shelf labels (ESLs).

7. The computer-implemented method of claim 4, further comprising a step of superimposing category matrix information of the graph of GM %.

8. The computer-implemented method of claim 4, further comprising a step of determining a price, P, for an item according to the equation P=¾·C+¼·P·(ε−1)/ε where C is the cost of the item and ε is an elasticity value for the item according to the equation ε=((Qₙ−Q₀)/Q₀)/((Pₙ−P₀)/P₀) where Q₀ is the original quantity sold at price P₀ and Qₙ is the new quantity sold at price Pₙ.

9. The computer-implemented method of claim 4, further comprising a step of determining a price, P, for an item according to the equation P=√(C·P·(ε−1)/ε), where C is the cost of the item and ε is an elasticity value for the item according to the equation ε=((Qₙ−Q₀)/Q₀)/((Pₙ−P₀)/P₀) where Q₀ is the original quantity sold at price P₀ and Q₀ is the new quantity sold at price Pₙ.

10. The computer-implemented method of claim 4, further comprising a step of determining a price, P, for an item according to the equation P=C·(α−1)/α), where C is the cost of the item and α is an elasticity value for the item according to the equation α=((ln(Qₙ/Q₀) (ln(Pₙ/P₀)) according to the equation ε=((Qₙ−Q₀)/Q₀)/((Pₙ−P₀)/P₀) where Q₀ is the original quantity sold at price P₀ and Qₙ is the new quantity sold at price Pₙ.

11. A method for optimizing prices of fast moving, long life cycle items in consumer package goods retail outlets, using a computer having a display, one or more processors, and one or more memories storing data and one or more programs for execution by the one or more processors, said method comprising the steps of:
receiving sales and cost data for one or more items;
displaying a graphical user interface on the display, wherein the graphical user interface comprises one or more graphs of sales and gross margin percent (GM %) for a plurality of items and iteratively updating the graphs based on user selected optimization parameters; and
outputting new prices for the one or more items based on the optimization.

12. The method of claim 11, wherein the displaying step further comprises the steps of:
calculating a first total sales figure for all items in a set of items;
generating a graph of the set of items in order of descending sales indexed to a range between a maximum and minimum item sales;
calculating a GM % for each item in the set of items between user-selected minimum and maximum values of GM %, based on an inverse of its sales index, and generating a graph of the GM % for each item, in the same order;
calculating a new price for each item in the set of items based on the calculated GM % for each item;
calculating a second total sales figure for all of the items in the set of items based on the new prices;
calculating a difference between the first and second total sales figures; and
if the difference is larger than a threshold, returning to the step of generating a graph of the set of items in order of descending sales, otherwise stopping the iteration.

13. The method of claim 12, further comprising a step of superimposing category matrix information of the graph of GM %.

14. The method of claim 12, wherein the GM % is calculated assuming a static demand or movement.

15. The method of claim 12 wherein a user can select a dynamic model for demand or movement when calculating the GM % for each item.

16. The method of claim 11, further comprising a step of determining a price, P, for an item according to the equation P=¾·C+¼·P·(ε−1)/ε where C is the cost of the item and ε is an elasticity value for the item according to the equation ε=((Qₙ−Q₀)/Q₀)/((Pₙ−P₀)/P₀) where Q₀ is the original quantity sold at price P₀ and Qₙ is the new quantity sold at price Pₙ.

17. The method of claim 11, further comprising a step of determining a price, P, for an item according to the equation P=√(C·P·(ε−1)/ε), where C is the cost of the item and ε is an elasticity value for the item according to the equation ε=((Qₙ−Q₀)/Q₀)/((Pₙ−P₀)/P₀) where Q₀ is the original quantity sold at price P₀ and Qₙ is the new quantity sold at price Pₙ.

18. The method of claim 11, further comprising a step of determining a price, P, for an item according to the equation P=C·(α−1)/α), where C is the cost of the item and α is an elasticity value for the item according to the equation α=((ln(Qₙ/Q₀)/(ln(Pₙ/P₀)) according to the equation ε=((Qₙ−Q₀)/Q₀)/((Pₙ−P₀)/P₀) where Q₀ is the original quantity sold at price P₀ and Qₙ is the new quantity sold at price Pₙ.

19. The method of claim 11 wherein the step of outputting prices device further comprises printing labels indicating a price for the at least one unit, or sending pricing information over an RFID or Wi-Fi network to electronic shelf labels (ESLs).

20. The method of claim 11, further comprising the steps of:
detecting user actions to manipulate one or more parameters controlling the graphs so as to simulate price changes for the one or more items; and
updating the graphical user interface based on the changed parameters to optimize prices for the one or more items.
